(19) United States
(12) Patent Application Publication
(10) Pub. No.: US 2012/0089693 A1
(43) Pub. Date: Apr. 12, 2012

(54) Method for Negotiating Message Session Relay Protocol Connection Parameters

(76) Inventors: Yan Lu, Guangdong Province (CN); Ghazanfar Ali, Guangdong Province (CN); Jun Chen, Guangdong Province (CN); Lizhe Yao, Guangdong Province (CN); Man Xie, Guangdong Province (CN); Huan Guo, Guangdong Province (CN)

(21) Appl. No.: 13/376,711

(22) PCT Filed: Jan. 19, 2010
(86) PCT No.: PCT/CN2010/070260

§ 371 Date: Dec. 7, 2011

(30) Foreign Application Priority Data
Jun. 10, 2009 (CN) 200910108037.5

(51) Int. Cl. G06F 15/16

(52) U.S. Cl. 709/206; 709/228

(57) ABSTRACT

The present invention discloses a method for negotiating MSRP connection parameters. The method comprises completing the negotiation of the MSRP parameters via a SDP negotiation process between a CPM client at the transmitting side, an originating participation function entity, a terminating participation function entity and a CPM client at the receiving side, that is, carrying the MSRP connection parameters of a transmitter of a SDP datagram in the SDP datagram carried in a session invite message and/or a success response message message. The present invention solves the problem in the prior art that the negotiation of the MSRP connection parameters cannot be achieved by a MSRP transmission link, thereby improving a scheme of transmitting a large message mode CPM message.

### TECHNICAL FIELD

The present invention relates to the field of converged IP messaging (CPM) communication, and more particularly, to a method for negotiating message session relay protocol (MSRP) connection parameters used in a process of transmitting a large message mode CPM message.

### BACKGROUND OF THE RELATED ART

A purpose of converged IP messaging (CPM), which is proposed by the Open Mobile Architecture (OMA) in 2005, is to achieve the interworking among a variety of message services, provide a unified message service and improve information service experience. The CPM integrates many existing message services, including Instant Message (IM), Push-To-Talk over Cellular (POC), Mobile E-Email (MEM), Short Messaging Service (SMS), Multimedia Messaging Service (MMS), etc.

Main service modes of the CPM comprise pager-mode based CPM, session-mode based Large Message Mode CPM Message, and other session based CPM Session Services. Before users use these services normally, they need to log on to a CPM system, which is known as “on-line” generally.

Pager-mode messages are transferred between CPM Clients and CPM Enablers at both a transmitting side and a receiving side using a Session Initiation Protocol (SIP) message (SIP message). When a terminal at the transmitting side needs to send a large message mode CPM message, if the size of the message exceeds a limit (for example, is larger than 1300 bytes), the message cannot be carried by the SIP message.

The CPM services support CPM Pre-defined Group and CPM Ad-hoc Group. CPM users may send CPM paging messages to a CPM pre-defined group or a CPM ad-hoc group. When the size of the message exceeds a certain limit, however, it cannot be carried by the SIP message.

A transmission path of the large message mode CPM message can be divided into a signaling path and a media path, that is, signaling is transmitted along the signaling path, and media is transmitted along the media path. When the large message mode CPM message is transmitted, a session invite message (INVITE) of the large message mode CPM message is used to establish a session between a CPM client at the transmitting side and a CPM client at the receiving side to complete media negotiation and establish a transmission link between the CPM client at the transmitting side and the CPM client at the receiving side, use the Message Session Relay Protocol (MSRP) to send media content of the large message mode CPM message, i.e., content of the CPM message, to the CPM client at the receiving side via the established transmission link.

According to a system framework of the CPM, at the service level, the signaling path along which large messages of the CPM are transmitted is required to pass the CPM client at the transmitting side, the transmitting side belonged originating participation function entity, the receiving side belonged terminating participation function entity, and the CPM client at the receiving side. There are two schemes for establishing the media path of the CPM, one being to establish the media path between the CPM clients without passing the participation function entities and control function entities, the other needing passing the participation function entities.

When the scheme of passing the participation function entities is used to implement the establishing of the media path, the media path should be established between the CPM client at the transmitting side and the originating participation function entity, between the originating participation function entity and the terminating participation function entity, and between the terminating participation function entity and the CPM client at the receiving side so as to achieve multiple hops transmission of the MSRP. However, currently there is no method for each function entity to know an adjacent function entity that establishes a link therewith yet, that is, each function entity cannot acquire the MSRP connection parameters (including information of IP address, port number and/or MSRP URI) of the entities with which it establishes a link, thus going against the negotiation of the connection parameters required to establish the MSRP multiple hops transmission path between various function entities.

### CONTENT OF THE INVENTION

In view of this, the present invention provides a method for negotiating MSRP connection parameters so as to solve the problem in the prior art that the connection parameters required to establish a MSRP multiple hops transmission path cannot be negotiated between various function entities when a large message mode CPM message is transmitted.

To solve the above problem, the present invention provides a method for negotiating MSRP connection parameters comprising:

completing the negotiation of the MSRP parameters via a SDP negotiation process between a CPM client at the transmitting side, an originating participation function entity, a terminating participation function entity and a CPM client at the receiving side.

The SDP negotiation process comprises:

the CPM client at the transmitting side sending a first session invite message of a large message mode CPM message to the originating participation function entity, the first session invite message carrying a first SDP datagram;

after receiving the first session invite message, the originating participation function entity generating and sending a second session invite message to the terminating participation function entity, the second session invite message carrying a second SDP datagram;

after receiving the second session invite message, the terminating participation function entity generating and sending a third session invite message to the CPM client at the receiving side, the third session invite message carrying a third SDP datagram;

after receiving the third session invite message, the CPM client at the receiving side generating and sending a third success response message to the terminating participation function entity, the third success response message carrying a third response SDP datagram;

after receiving the third success response message, the terminating participation function entity generating and sending a second success response message to the originating participation function entity, the second success response message carrying a second response SDP datagram; and

after receiving the second success response message, the originating participation function entity generating and sending a first success response message to the CPM client at the transmitting side, the first success response message carrying a first response SDP datagram.

The first session invite message, the second session invite message, the third session invite message, the third success response message, the second success response message and the first success response message are routed via a SIP/IP core network.

The completing the negotiation of the MSRP parameters via the SDP negotiation process comprises:

the CPM client at the transmitting side carrying its MSRP connection parameter information by the first SDP datagram carried in the first session invite message;

the originating participation function entity carrying its MSRP connection parameter information by the second SDP datagram carried in the second session invite message; and

the terminating participation function entity carrying its MSRP connection parameter information by the third SDP datagram carried in the third session invite message.

The completing the negotiation of the MSRP parameters via the SDP negotiation process comprises:

the CPM client at the receiving side carrying its MSRP connection parameter information by the third response SDP datagram carried in the third success response message;

the terminating participation function entity carrying its MSRP connection parameter information by the second response SDP datagram carried in the second success response message; and

the originating participation function entity carrying its MSRP connection parameter information by the first response SDP datagram carried in the first success response message;

The completing the negotiation of the MSRP parameters via the SDP negotiation process comprises:

the CPM client at the transmitting side carrying its MSRP connection parameter information by the first SDP datagram carried in the first session invite message;

the originating participation function entity carrying its MSRP connection parameter information into the second SDP datagram carried in the second session invite message;

the terminating participation function entity carrying its MSRP connection parameter information by the third SDP datagram carried in the third session invite message;

the CPM client at the receiving side carrying its MSRP connection parameter information by the third response SDP datagram carried in the third success response message;

the terminating participation function entity carrying its MSRP connection parameter information by the second response SDP datagram carried in the second success response message; and

the originating participation function entity carrying its MSRP connection parameter information by the first response SDP datagram carried in the first success response message.

The completing the negotiation of the MSRP parameters via the SDP negotiation process comprises:

the originating participation function entity carrying its MSRP connection parameter information by the first response SDP datagram carried in the first success response message;

the terminating participation function entity carrying its MSRP connection parameter information by the third SDP datagram carried in the third session invite message; and

the originating participation function entity carrying its MSRP connection parameter information by the second SDP datagram carried in the second session invite message.

The completing the negotiation of the MSRP parameters via the SDP negotiation process comprises:

the originating participation function entity carrying its MSRP connection parameter information by the first response SDP datagram carried in the first success response message;

the terminating participation function entity carrying its MSRP connection parameter information by the third SDP datagram carried in the third session invite message; and

the terminating participation function entity carrying its MSRP connection parameter information by the second response SDP datagram carried in the second success response message.

The MSRP connection parameter is a uniform resource identifier (URI).

The MSRP connection parameters are an IP address and a port number.

The MSRP connection parameters are a URI, an IP address and a port number.

A MSRP URI is carried in the second session invite message and the third session invite message, which means that:

a value of a path header field in the received first SDP datagram is preserved in the second SDP datagram, and a MSRP URI of the originating participation function entity is added to the most left side of the path header field in the second SDP datagram; a value of a path header field in the received second SDP datagram is preserved in the third SDP datagram, and a MSRP URI of the terminating participation function entity is added to the most left side of the path header field in the third SDP datagram.

or only the MSRP URI of the originating participation function entity is carried in the path header field in the second SDP datagram; and only the MSRP URI of the terminating participation function entity is carried in the path header field in the third SDP datagram.

The IP address is carried using a SDP connection parameter row c-field, and the port number is carried using a SDP media parameter row m-field.

A MSRP URI is carried in the second session invite message and the third session invite message, which means that:

a value of a path header field in the received first SDP datagram is preserved in the second SDP datagram, and a MSRP URI of the originating participation function entity is added to the most left side of the path header field in the second SDP datagram; a value of a path header field in the received second SDP datagram is preserved in the third SDP datagram, and a MSRP URI of the terminating participation function entity is added to the most left side of the path header field in the third SDP datagram.

or only the MSRP URI of the originating participation function entity is carried in the path header field in the second SDP datagram; and only the MSRP URI of the terminating participation function entity is carried in the path header field in the third SDP datagram.

A MSRP URI is carried in the second success response message and the first success response message, which means that:

a value of a path header field in the received third response SDP datagram is preserved in the second response SDP datagram, and a MSRP URI of the terminating participation function entity is added to the most left side of the path header field in the second response SDP datagram; a value of a path header field in the received second response SDP datagram is preserved in the first response SDP datagram, and a MSRP URI of the originating participation function entity is added to the most left side of the path header field in the first SDP datagram;

or only the MSRP URI of the terminating participation function entity is carried in the path header field in the second response SDP datagram; and only the MSRP URI of the originating participation function entity is carried in the path header field in the first response SDP datagram.

The IP address is carried using a SDP connection parameter row c-field, and the port number is carried using a SDP media parameter row m-field.

A MSRP URI is carried in the second success response message and the first success response message, which means that:

a value of a path header field in the received third response SDP datagram is preserved in the second response SDP datagram, and a MSRP URI of the terminating participation function entity is added to the most left side of the path header field in the second response SDP datagram; a value of a path header field in the received second response SDP datagram is preserved in the first response SDP datagram, and a MSRP URI of the originating participation function entity is added to the most left side of the path header field in the first SDP datagram;

or only the MSRP URI of the terminating participation function entity is carried in the path header field in the second response SDP datagram; and only the MSRP URI of the originating participation function entity is carried in the path header field in the first response SDP datagram.

The IP address is carried using a SDP connection parameter row c-field, and the port number is carried using a SDP media parameter row m-field.

Using the aforementioned scheme can solve the problem in the prior art that the negotiation of the MSRP connection parameters cannot be implemented by the MSRP transmission link so as to improve the transmission scheme of the large message mode CPM message.

The other features and advantages of the present invention will be described in the following description, and will become obvious partially from the description or be understood by implementing the present invention. Objects and other advantages of the present invention can be implemented and acquired via the written description, claims and structures specially pointed out in the accompanying figures.

### BRIEF DESCRIPTION OF DRAWINGS

FIG. 1 is a schematic diagram of negotiation of MSRP connection parameters of media transmission links of a large message mode CPM message in accordance with the present invention;

FIG. 2 is a flow chart of negotiation of MSRP connection parameters in a SDP negation process of a large message mode CPM message in accordance with the present invention; and

FIG. 3 is a flow chart of a method for negotiating MSRP connection parameters in accordance with the first embodiment of the present invention.

### PREFERRED EMBODIMENTS OF THE PRESENT INVENTION

Since a large message mode CPM message occupies relatively large space, it cannot be directly carried by a SIP message. Unlike a method for transmitting a pager-mode CPM message, a transmission path of the large message mode CPM message is divided into a signaling path and a media path, that is, signaling is transmitted along the signaling path and media is transmitted along the media path. Therefore, in an embodiment of the present invention, when the large message mode CPM message is transmitted, a session invite message (SIP INVITE) of the large message mode CPM message is used to establish a session between a CPM client at the transmitting side and a CPM client at the receiving side to complete media negotiation and establish a transmission link between the CPM client at the transmitting side and the CPM client at the receiving side, use the Message Session Relay Protocol (MSRP) to send media content of the large message mode CPM message, i.e., content of the CPM message, to the CPM client at the receiving side via the established transmission link. Under technical background of the whole technical scheme, the present invention provides a specific implementation scheme for a complete media negotiation.

It should be noted that the large message mode CPM message mentioned in the embodiments of the present invention is a CPM message whose size is larger than a preset threshold (e.g., 1300 bytes) in the CPM specification formulated for the OMA, and this large message mode CPM message cannot be directly carried using the SIP message.

In the case of no conflict, the embodiments in the present application and the features in the embodiments can be combined.

The preferred embodiments of the present invention will be described below in conjunction with the accompanying figures. It should be understood that the preferred embodiments described herein are intended to only illustrate and explain the present invention not to restrict the present invention.

According to one embodiment of the present invention, first, a method is provided for negotiating MSRP parameters of a media transmission link of a large message mode CPM message. Using the method, each function entity participating in a process of transmitting the large message mode CPM message acquires the MSRP connection parameters of an adjacent function entity that establishes a link therewith.

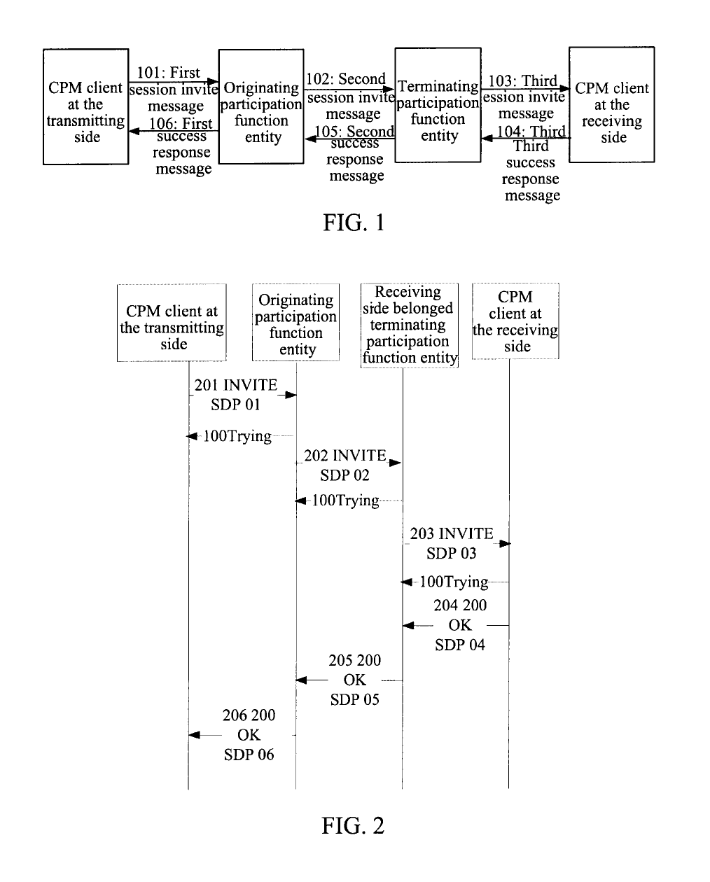

FIG. 1 is a schematic diagram of negotiation of MSRP connection parameters of media transmission links of a large message mode CPM message in accordance with the present invention. As shown in FIG. 1, when a CPM client sends a large message mode CPM message to another CPM client, a process of negotiating the MSRP connection parameters mainly comprises the following steps.

Step 101: a CPM client at a transmitting side sends a first session invite message of the large message mode CPM message carrying a first session description protocol (SDP) datagram. The first session invite message is routed to an originating participation function entity via a SIP/IP core network.

Step 102: after the originating participation function entity receives the first session invite message, it generates and sends a second session invite message carrying a second SDP datagram. The second session invite message is routed to a terminating participation function entity via the SIP/IP core network.

Step 103: after the terminating participation function entity receives a second session invite message, it generates and sends a third session invite message carrying a third SDP datagram. The third session invite message is routed to a CPM client at a receiving side via the SIP/IP core network.

Step 104: after the CPM client at the receiving side receives a third session invite message, it generates and sends a third success response message carrying a third response SDP datagram. The third success response message is routed to the originating participation function entity via the SIP/IP core network.

Step 105: after the terminating participation function entity receives a third success response message, it generates and sends a second success response message carrying the second response SDP datagram. The second success response message is routed to the originating participation function entity via the SIP/IP core network.

Step 106: after the originating participation function entity receives a second success response message, it generates and sends a first success response message carrying the first response SDP datagram. The first success response message is routed to the CPM client at the transmitting side via the SIP/IP core network.

Using the first, second, and third SDP datagrams carried in the first, second and third session invite messages and/or the first, second and third response SDP datagrams carried in the first, second and third success response messages, the negotiation of the MSRP connection parameters can be achieved between the CPM client at the transmitting side, the originating participation function entity, the terminating participation function entity and the CPM client at the receiving side. Specifically, several schemes will be described below.

Scheme one: the MSRP connection parameters of the transmitting side of each session invite message are carried by the SDP datagrams in the first, second or third session invite message. Thus, each receiving side of each session invite message can acquire the MSRP connection parameters of its transmitting side. That is, the CPM client at the transmitting side carries its MSRP connection parameter information by the first SDP datagram carried in the first session invite message; the originating participation function entity carries its MSRP connection parameter information by the second SDP datagram carried in the second session invite message; and the terminating participation function entity carries its MSRP connection parameter information by the third SDP datagram carried in the third SIP session invite message.

Scheme two: the MSRP connection parameters of the transmitting side of each response message are carried by the response SDP datagrams in the first, second or third success response message. Thus, each transmitting side of each session invite message can acquire the MSRP connection parameters of its receiving side. That is, the CPM client at the receiving side carries its MSRP connection parameter information by the third response SDP datagram carried in the third success response message; the terminating participation function entity carries its MSRP connection parameter information by the second response SDP datagram carried in the second success response message; and the originating participation function entity carries its MSRP connection parameter information by the first response SDP datagram carried in the first success response message.

Scheme three: the CPM client at the transmitting side and the CPM client at the receiving side acquire the MSRP connection parameters of network entities at their opposite sides respectively. That is, the originating participation function entity carries its MSRP connection parameter information by the first response SDP datagram carried in the first success response message; the terminating participation function entity carries its MSRP connection parameter information by the third SDP datagram carried in the third session invite message; and the originating participation function entity carries its MSRP connection parameter information by the second SDP datagram carried in the second session invite message. Or, the originating participation function entity carries its MSRP connection parameter information by the first response SDP datagram carried in the first success response message; the terminating participation function entity carries its MSRP connection parameter information by the third SDP datagram carried in the third session invite message; and the terminating participation function entity carries its MSRP connection parameter information by the second response SDP datagram carried in the second success response message.

Scheme four: each of the session invite messages and success response messages carry the MSRP connection parameters of the transmitting side of this message. The particular steps in Scheme four are similar to those in Scheme one and Scheme two, and will not be repeated herein.

FIG. 2 is a flow chart of negotiation of MSRP connection parameters in a SDP negation process of a large message mode CPM message in accordance with the present invention. A SIP/IP Core function node is omitted in FIG. 2. Actually, signaling transmission between every two function entities in this figure is implemented by a SIP/IP core network. The omission is not a limitation to the present invention.

As shown in FIG. 2, when a CPM client sends a large message mode CPM message to another CPM client, a process for negotiating the MSRP connection parameters mainly comprises the following steps.

Step 201: a CPM client at a transmitting side sends a session invite message (SIP INVITE) of the large message mode CPM message to another CPM client. The CPM client at the transmitting side carries a SDP datagram containing MSRP connection parameter information (including information of IP address, port number and/or URI) by the session invite message. The session invite message is routed to an originating participation function entity, i.e., a transmitting side belonged participation function entity, via a SIP/IP core network.

Step 202: the originating participation function entity receives the session invite message sent in step 201 and acts as a back to back user agent (B2BUA) to process the received message, generates and sends a new session invite message containing a SDP datagram, and carries its MSRP connection parameter information by the datagram.

Here, the MSRP connection parameters are an IP address and a port number, where the IP address can be carried using a SDP connection parameter row c-field, and the port number can be carried suing a SDP media parameter row m-field.

If the MSRP connection parameter is a MSRP URI, the method for carrying the MSRP URI in the message comprises preserving a value of a path header field in the received SDP datagram into the SDP datagram, and adding a MSRP URI of the originating participation function entity to the most left side of the path header field in the SDP datagram; or carrying only the MSRP URI of the originating participation function entity in the path header field in the SDP datagram. The originating participation function entity sends the newly generated session invite message that is routed to the terminating participation function entity, i.e., a receiving side belonged participation function entity, via the SIP/IP core network.

If the MSRP connection parameters are the IP address, the port number and the MSRP URI, where the IP address can be carried using the SDP connection parameter row c-field and the port number can be carried using the SDP media parameter row m-field, the method for carrying the MSRP URI in the message comprises preserving a value of a path header field in the received SDP datagram into the SDP datagram, and adding a MSRP URI of the originating participation function entity to the most left side of the path header field in the SDP datagram; or carrying only the MSRP URI of the originating participation function entity in the path header field in the SDP datagram. The originating participation function entity sends the newly generated session invite message that is routed to the terminating participation function entity, i.e., a receiving side belonged participation function entity, via the SIP/IP core network.

Step 203: the terminating participation function entity receives the session invite message sent in step 202 and acts as a B2BUA to process the received message, generates and sends a new session invite message carrying a SDP datagram, and carries its MSRP connection parameter information by the datagram.

Here, the MSRP connection parameters are an IP address and a port number, wherein the IP address can be carried using the SDP connection parameter row c-field and the port number can be carried using the SDP media parameter row m-field.

If the MSRP connection parameter is a MSRP URI, the method for carrying the MSRP URI in the message comprises preserving a value of a path header field in the received SDP datagram into the SDP datagram, and adding a MSRP URI of the terminating participation function entity to the most left side of the path header field in the SDP datagram; or only carrying the MSRP URI of the terminating participation function entity in the path header field in the SDP datagram. The terminating participation function entity sends the newly generated session invite message that is routed to the CPM client at the receiving side via the SIP/IP core network.

If the MSRP connection parameters are the IP address, the port number and the MSRP URI, where the IP address can be carried using the SDP connection parameter row c-field and the port number can be carried suing the SDP media parameter row m-field, the method for carrying the MSRP URI in the message comprises preserving a value of a path header field in the received SDP datagram into the SDP datagram, and adding a MSRP URI of the terminating participation function entity to the most left side of the path header field in the SDP datagram; or only carrying the MSRP URI of the terminating participation function entity in the path header field in the SDP datagram. The terminating participation function entity sends the newly generated session invite message that is routed to the CPM client at the receiving side via the SIP/IP core network.

Step 204: after the CPM client at the receiving side receives the session invite message sent in step 203, it sends a success response message SIP 200 OK carrying a response SDP datagram, and carries its MSRP connection parameter information by the datagram. The success response message is routed to the terminating participation function entity via the SIP/IP core network.

Step 205: after the terminating participation function entity receives the success response message sent in step 204, it acts as a B2BUA to process the received message, generates and sends a new success response message SIP 200 OK carrying a SDP datagram, and carries its MSRP connection parameter information by the datagram.

Here, the MSRP connection parameters are an IP address and a port number, wherein the IP address can be carried suing the SDP connection parameter row c-field and the port number can be carried suing the SDP media parameter row m-field.

If the MSRP connection parameter is a MSRP URI, the method for carrying the MSRP URI by the SDP datagram may comprise preserving a value of the received path header field into the sent SDP datagram, and adding a MSRP URI of the present function entity to the most left side of the path header field; or only carrying the MSRP URI of the present function entity in the path header field in the success response message. The success response message is routed to the originating participation function entity via the SIP/IP core network.

If the MSRP connection parameters are an IP address, a port number and a MSRP URI, where the IP address can be carried using the SDP connection parameter row c-field and the port number can be carried using the SDP media parameter row m-field, the method for carrying the MSRP URI by the SDP may comprise preserving a value of the received path header field into the sent SDP datagram, and adding a MSRP URI of the present function entity to the most left side of the path header field; or only carrying the MSRP URI of the present function entity in the path header field in the success response message. The success response message is routed to the originating participation function entity via the SIP/IP core network.

Step 206: after the originating participation function entity receives the response message sent in step 205 and acts as a B2BUA to process the received message, it generates and sends a new success response message SIP 200 OK carrying a SDP datagram, and carries its MSRP connection parameter information by the datagram.

Here, the MSRP connection parameters are an IP address and a port number, wherein the IP address can be carried using the SDP connection parameter row c-field and the port number can be carried using the SDP media parameter row m-field.

If the MSRP connection parameter is a MSRP URI, the method for carrying the MSRP URI by the SDP datagram may comprise preserving a value of the received path header field into the sent SDP datagram, and adding a MSRP URI of the present function entity to the most left side of the path header field; or only carrying the MSRP URI of the present function entity in the path header field in the success response message. The success response message is routed to the CPM client at the transmitting side via the SIP/IP core network.

If the MSRP connection parameters are an IP address, a port number and a MSRP URI, where the IP address can be carried using the SDP connection parameter row c-field and the port number can be carried using the SDP media parameter row m-field, the method for carrying the MSRP URI by the SDP datagram may comprise preserving a value of the received path header field into the sent SDP datagram, and adding a MSRP URI of the present function entity to the most left side of the path header field; or only carrying the MSRP URI of the present function entity in the path header field in the success response message. The success response message is routed to the CPM client at the transmitting side via the SIP/IP core network.

### The First Embodiment

Taking carrying a MSRP URI for an example, this embodiment assume that a CPM client at a transmitting side is CPM Client A, an effective binding address of which is CPM Address A, i.e., a transmitting side belonged Participating Function Entity A, and that a CPM client at a receiving side is CPM Client B, an effective binding address of which is CPM Address B, i.e., a receiving side belonged Participating Function Entity B.

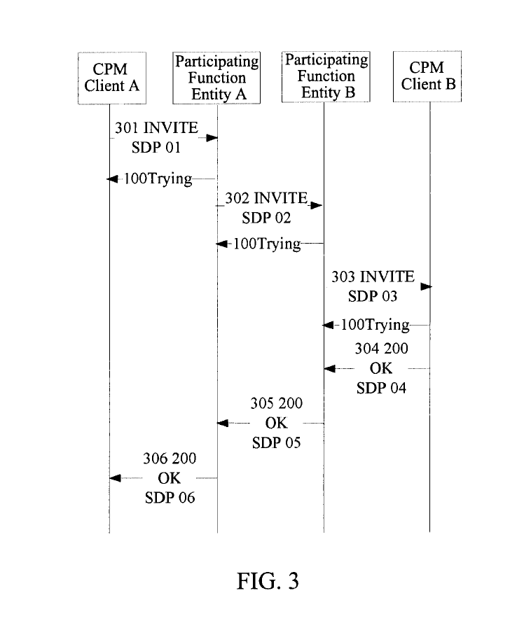

FIG. 3 is a flow chart of a method for negotiating MSRP connection parameters in accordance with the first embodiment of the present invention. As shown in FIG. 3, in the first embodiment, when CPM Client A sends a large message mode CPM message to CPM Client B, if the message carries a MSRP URI, the required process for negotiating the MSRP URI mainly comprises the following steps.

Step 301: CPM Client A sends a session invite message carrying a SDP datagram to CPM Client B (a Request-URI is CPM Address B), and carries its MSRP URI by the SDP datagram.

In the session invite message sent in this step, the MSRP URI contained in the path header information in the SDP datagram is as follows:

a=path: msrps://A.example.com/aaaaaa;tcp

This session invite message is routed to Participating Function Entity A via a SIP/IP core network.

Step 302: Participating Function Entity A receives the session invite message, generates and sends a new session invite message carrying the SDP datagram, and carries its MSRP URI by the datagram.

In the session invite message sent in this step, the MSRP URI contained in the path header information in the SDP datagram is as follows:

a=path: msrps://PFA.example.com/pfapfa;tcp
or
a=path: msrps://PFA.example.com/pfapfa;tcp \
a=path: msrps://A.example.com/aaaaaa;tcp

This session invite message is routed to Participating Function Entity B via a SIP/IP core network.

Step 303: Participating Function Entity B receives the session invite message, generates and sends a new session invite message carrying the SDP datagram, and carries its MSRP URI by the datagram.

In the session invite message sent in this step, the MSRP URI contained in the path header information in the SDP datagram is as follows:

a=path: msrps://PFB.example.com/pfbpfb;tcp
or
a=path: msrps://PFB.example.com/pfbpfb;tcp \
a=path: msrps://PFA.example.com/pfapfa;tcp \
a=path: msrps://A.example.com/aaaaaa;tcp

This session invite message is routed to Participating Function Entity B via a SIP/IP core network.

Step 304: CPM Client B receives the session invite message and sends a session invite message response message SIP 200 OK carrying a response SDP datagram, and carries its MSRP URI by the datagram.

In the response message sent in this step, the MSRP URI contained in the path header information in the SDP datagram is as follows:

a=path: msrps://B.example.com/bbbbbb;tcp

This session invite message is routed to Participating Function Entity B via a SIP/IP core network.

Step 305: Participating Function Entity B receives the response message SIP 200 OK carrying the response SDP datagram, generates and sends a new response message SIP 200 OK, and carries its MSRP URI by the datagram.

In the response message sent in this step, the MSRP URI contained in the path header information in the SDP datagram is as follows:

a=path: msrps://PFB.example.com/pfbpfb;tcp
or
a=path: msrps://PFB.example.com/pfbpfb;tcp \
msrps://B.example.com/bbbbbb;tcp

This session invite message is routed to Participating Function Entity A via a SIP/IP core network.

Step 306: Participating Function Entity A receives the response message SIP 200 OK carrying the response SDP datagram, generates and sends a new response message SIP 200 OK, and carries its MSRP URI by the datagram.

In the response message sent in this step, the MSRP URI contained in the path header information in the SDP datagram is as follows:

a=path: msrps://PFA.example.com/pfapfa;tcp
or
a=path: msrps://PFA.example.com/pfapfa;tcp \
msrps://PFB.example.com/pfbpfb;tcp \
msrps://B.example.com/bbbbbb;tcp

This session invite message is routed to Participating Function Entity A via a SIP/IP core network.

The negotiation of the MSRP connection parameters is described in the above embodiments, for example, the MSRP connection parameters carried in both the session invite message and the success response message are negotiated, or the MSRP connection parameters carried in either the session invite message or the success response message is negotiated, or the MSRP connection parameters acquired by the client at the transmitting side or the client at the receiving side from their opposite sides are negotiated.

The method for carrying a MSRP URI can a method for adding the MSRP URI by using per-hop or a method for exchanging the MSRP URI only between adjacent function entities.

In the method for carrying an IP address and a port number, the IP address may be carried using the SDP connection parameter row c-field and the port number may be carried using the media parameter row m-field.

As described above, using the technical scheme provided in the embodiments of the present invention, information is exchanged by carrying the SDP datagram in the session inviter message and the success response message of the large message mode CPM message so as to provide a solution to the negotiation of the MSRP connection parameters required to establish the media link between multiple network function entities.

The above description is only preferred embodiments of the present invention and is not intended to limit the present invention. Various modifications and variations may be made to the present invention by those skilled in the art. Any modification, equivalent substitution or improvement made within the spirit and principle of the present invention should be included in the protection scope of the present invention.

What is claimed is:

1. A method for negotiating MSRP connection parameters comprising:
completing the negotiation of the MSRP parameters via a SDP negotiation process between a CPM client at the transmitting side, an originating participation function entity, a terminating participation function entity and a CPM client at the receiving side.

2. The method according to claim 1, wherein the SDP negotiation process comprises:
the CPM client at the transmitting side sending a first session invite message of a large message mode CPM message to the originating participation function entity, the first session invite message carrying a first SDP datagram;
after receiving the first session invite message, the originating participation function entity generating and sending a second session invite message to the terminating participation function entity, the second session invite message carrying a second SDP datagram;
after receiving the second session invite message, the terminating participation function entity generating and sending a third session invite message to the CPM client at the receiving side, the third session invite message carrying a third SDP datagram;
after receiving the third session invite message, the CPM client at the receiving side generating and sending a third success response message to the terminating participation function entity, the third success response message carrying a third response SDP datagram;
after receiving the third success response message, the terminating participation function entity generating and sending a second success response message to the originating participation function entity, the second success response message carrying a second response SDP datagram; and
after receiving the second success response message, the originating participation function entity generating and sending a first success response message to the CPM client at the transmitting side, the first success response message carrying a first response SDP datagram.

3. The method according to claim 2, wherein the first session invite message, the second session invite message, the third session invite message, the third success response message, the second success response message and the first success response message are routed via a SIP/IP core network.

4. The method according to claim 2, wherein the completing the negotiation of the MSRP parameters via the SDP negotiation process comprises:
the CPM client at the transmitting side carrying its MSRP connection parameter information by the first SDP datagram carried in the first session invite message;
the originating participation function entity carrying its MSRP connection parameter information by the second SDP datagram carried in the second session invite message; and
the terminating participation function entity carrying its MSRP connection parameter information by the third SDP datagram carried in the third session invite message.

5. The method according to claim 2, wherein the completing the negotiation of the MSRP parameters via the SDP negotiation process comprises:
the CPM client at the receiving side carrying its MSRP connection parameter information by the third response SDP datagram carried in the third success response message;
the terminating participation function entity carrying its MSRP connection parameter information by the second response SDP datagram carried in the second success response message; and
the originating participation function entity carrying its MSRP connection parameter information by the first response SDP datagram carried in the first success response message;

6. The method according to claim 2, wherein the completing the negotiation of the MSRP parameters via the SDP negotiation process comprises:
the CPM client at the transmitting side carrying its MSRP connection parameter information by the first SDP datagram carried in the first session invite message;
the originating participation function entity carrying its MSRP connection parameter information into the second SDP datagram carried in the second session invite message;
the terminating participation function entity carrying its MSRP connection parameter information by the third SDP datagram carried in the third session invite message;
the CPM client at the receiving side carrying its MSRP connection parameter information by the third response SDP datagram carried in the third success response message;
the terminating participation function entity carrying its MSRP connection parameter information by the second response SDP datagram carried in the second success response message; and
the originating participation function entity carrying its MSRP connection parameter information by the first response SDP datagram carried in the first success response message.

7. The method according to claim 2, wherein the completing the negotiation of the MSRP parameters via the SDP negotiation process comprises:
the originating participation function entity carrying its MSRP connection parameter information by the first response SDP datagram carried in the first success response message;
the terminating participation function entity carrying its MSRP connection parameter information by the third SDP datagram carried in the third session invite message; and
the originating participation function entity carrying its MSRP connection parameter information by the second SDP datagram carried in the second session invite message.

8. The method according to claim 2, wherein the completing the negotiation of the MSRP parameters via the SDP negotiation process comprises:
the originating participation function entity carrying its MSRP connection parameter information by the first response SDP datagram carried in the first success response message;
the terminating participation function entity carrying its MSRP connection parameter information by the third SDP datagram carried in the third session invite message; and
the terminating participation function entity carrying its MSRP connection parameter information by the second response SDP datagram carried in the second success response message.

9. (canceled)

10. The method according to claim 1, wherein the MSRP connection parameters are an IP address and a port number.

11. The method according to claim 1, wherein the MSRP connection parameters are a URI, an IP address and a port number.

12. The method according to claim 9, wherein a MSRP URI is carried in the second session invite message and the third session invite message, which means that:
a value of a path header field in the received first SDP datagram is preserved in the second SDP datagram, and a MSRP URI of the originating participation function entity is added to the most left side of the path header field in the second SDP datagram; a value of a path header field in the received second SDP datagram is preserved in the third SDP datagram, and a MSRP URI of the terminating participation function entity is added to the most left side of the path header field in the third SDP datagram.
or only the MSRP URI of the originating participation function entity is carried in the path header field in the second SDP datagram; and only the MSRP URI of the terminating participation function entity is carried in the path header field in the third SDP datagram.

13. The method according to claim 11, wherein the IP address is carried using a SDP connection parameter row c-field, and the port number is carried using a SDP media parameter row m-field;
a MSRP URI is carried in the second session invite message and the third session invite message, which means that:
a value of a path header field in the received first SDP datagram is preserved in the second SDP datagram, and a MSRP URI of the originating participation function entity is added to the most left side of the path header field in the second SDP datagram; a value of a path header field in the received second SDP datagram is preserved in the third SDP datagram, and a MSRP URI of the terminating participation function entity is added to the most left side of the path header field in the third SDP datagram.
or only the MSRP URI of the originating participation function entity is carried in the path header field in the second SDP datagram; and only the MSRP URI of the terminating participation function entity is carried in the path header field in the third SDP datagram.

14. The method according to claim 9, wherein a MSRP URI is carried in the second success response message and the first success response message, which means that:
a value of a path header field in the received third response SDP datagram is preserved in the second response SDP datagram, and a MSRP URI of the terminating participation function entity is added to the most left side of the path header field in the second response SDP datagram; a value of a path header field in the received second response SDP datagram is preserved in the first response SDP datagram, and a MSRP URI of the originating participation function entity is added to the most left side of the path header field in the first SDP datagram;
or only the MSRP URI of the terminating participation function entity is carried in the path header field in the second response SDP datagram; and only the MSRP URI of the originating participation function entity is carried in the path header field in the first response SDP datagram.

15. The method according to claim 11, wherein the IP address is carried using a SDP connection parameter row c-field, and the port number is carried using a SDP media parameter row m-field;
a MSRP URI is carried in the second success response message and the first success response message, which means that:
a value of a path header field in the received third response SDP datagram is preserved in the second response SDP datagram, and a MSRP URI of the terminating participation function entity is added to the most left side of the path header field in the second response SDP datagram; a value of a path header field in the received second response SDP datagram is preserved in the first response SDP datagram, and a MSRP URI of the originating participation function entity is added to the most left side of the path header field in the first SDP datagram;
or only the MSRP URI of the terminating participation function entity is carried in the path header field in the second response SDP datagram; and only the MSRP URI of the originating participation function entity is carried in the path header field in the first response SDP datagram.

16. The method according to claim 10, wherein the IP address is carried using a SDP connection parameter row c-field, and the port number is carried using a SDP media parameter row m-field.
